(19) United States
(12) Patent Application Publication
(10) Pub. No.: US 2008/0164105 A1
(43) Pub. Date: Jul. 10, 2008

(54) Electromechanical Disk Brake With Self-Boosting

(76) Inventors: Dietmar Baumann, Hemmingen (DE); Dirk Hofmann, Ludwigsburg (DE); Herbert Vollert, Vaihingen/Enz (DE); Willi Nagel, Remseck/Hochdorf (DE); Andreas Henke, Diemelstatdt (DE); Bertram Foitzik, Ludwigsburg (DE); Bernd Goetzelmann, Moeglingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/567,261

(22) PCT Filed: Jul. 1, 2004
(86) PCT No.: PCT/DE2004/001389

§ 371 Date: Feb. 6, 2006

(30) Foreign Application Priority Data
Aug. 7, 2003 (DE) 103 36 284.3

(51) Int. Cl. F16D 55/22

(52) U.S. Cl. 188/72.2

(57) ABSTRACT

An electromechanical disk brake having a self-boosting by means of a ramp mechanism with an encapsulation to protect moving parts of the brake against becoming soiled. The friction brake lining has a three-point support with three roller bodies and thus is braced in a statically defined way, and a contate gear mechanism for actuating the disk brake, which is not vulnerable to positional tolerances and does not cause any axial forces.

### PRIOR ART

The invention relates to an electromechanical partial-lining disk brake with self-boosting, having the characteristics of the preamble to claim 1. A partial-lining disk brake is understood to be a disk brake whose friction brake lining, and any friction brake lining carrier, extends over only a portion of the circumference of the brake disk, typically over less than a quarter circle, unlike a full-lining disk brake, in which the friction brake lining, or a friction brake lining carrier ring equipped with a plurality of friction brake linings, extends over a full circle, or in other words, the brake disk covers the entire circumference. A full-lining disk brake is disclosed by German Patent Disclosure DE 198 19 564 A1.

Disk brakes of this kind are known per se. They have an actuating device with an electric motor, with which a friction brake lining is displaceable via one or more gear mechanisms and can be pressed for braking against a brake disk. Many wedge or ramp mechanisms are used as a self-booster, which guide the friction brake lining displaceably, obliquely at a typically acute angle to the brake disk. If the friction brake lining is pressed for braking against the rotating brake disk, then the brake disk exerts a frictional force in the circumferential direction on the friction brake lining, and this force urges the friction brake lining in the direction of an increasingly narrow wedge gap between the wedge or ramp and the brake disk. Because of the bracing of the friction brake lining on the wedge or ramp, the wedge or ramp exerts a contact pressure on the friction brake lining, as a reaction force, which additionally to the force exerted by the actuating device presses this friction brake lining against the brake disk. This kind of wedge or ramp mechanism forms a mechanical self-booster, which converts a frictional force, exerted by the rotating brake disk on the friction brake lining pressed against it, into a contact pressure that presses the friction brake lining against the brake disk.

### EXPLANATION AND ADVANTAGES OF THE INVENTION

The partial-lining disk brake of the invention, having the characteristics of claim 1, has a self-booster with a ramp mechanism, whose ramps extend helically and concentrically to one another and at least approximately coaxially to an axis of rotation of the brake disk. When the friction brake lining is pressed against the brake disk for braking, the ramps of the ramp mechanism guide the friction brake lining both transversely to the brake disk and approximately in a circular arc in the circumferential direction to the brake disk; that is, for braking, the friction brake lining is guided along an at least approximately helical path to the brake disk. The motion of the friction brake lining transversely to the brake disk can also be called feeding, or feed motion. The simultaneous motion in the circumferential direction need not extend either exactly in a circular arc nor exactly coaxially to the axis of rotation of the brake disk. An approximately circular-arclike guidance of the friction brake lining approximately coaxially to the brake disk suffices. The release is likewise done helically, in the opposite direction.

The ramps of the ramp mechanism have the same slope; that is, upon displacement of the friction brake lining in the circumferential direction of the brake disk by a defined circumferential angle, the motion of the friction brake lining transversely to the brake disk (feeding) is the same magnitude at all the ramps. The ramps can have different spacings from their common axis, or in other words can have different radii. The slope can change over the course of the ramps, for instance in order to achieve strong self-boosting at high braking and contact pressures and a high feeding speed transversely to the brake disk at the onset of the displacement of the friction brake lining. However, the slopes of all the ramps vary in common.

A partial-lining disk brake has the advantage of better cooling, particularly of the brake disk. The helical guidance of the friction brake lining of the partial-lining disk brake of the invention has the advantage that the friction brake lining upon braking is not moved outward relative to the brake disk, as it would do if it were being guided in a straight line, at a tangent to the brake disk. This decreases the space required by the disk brake, particularly in the direction of a wheel rim, in which the disk brake is typically disposed, and at a point where the installation space is always tight. A further advantage is that the friction brake lining is guided in the circumferential direction, and hence in the direction of motion of the brake disk, and not at an angle to the direction of motion of the brake disk, as in tangential guidance. The self-boosting effect is thus improved.

Advantageous features and refinements of the invention defined by claim 1 are the subject of the dependent claims.

Claim 3 provides three balls as roller bodies of the ramp mechanism, which brace the friction brake lining upon braking and which roll on the ramps upon the displacement of the friction brake lining. The three balls are disposed at the corners of an imaginary triangle; they form a three-point support for the friction brake lining. In this way, a statically defined and hence play-free bracing, despite tolerances, of the friction brake lining is attained.

Claim 5 provides a retainer for the roller bodies, which keeps the roller bodies in their spacing from and in their position relative to one another. The retainer is a so-called ball cage, of the kind known in ball bearings. The retainer assures a synchronous motion of the roller bodies.

According to claim 6, the partial-lining disk brake of the invention has an encapsulation of moving parts. Encapsulation means a casing that protects moving parts of the disk brake against dirt. Such moving parts are for instance a caliper guide, which guides a floating caliper of the disk brake displaceably, transversely to the brake disk (claim 7). The actuating device and the self-booster also have moving parts, which according to the invention may have an encapsulation (claim 8). The advantage of encapsulating moving parts is that soiling and a consequent increase in wear and in friction are avoided. Since the moving parts are lubricated, for instance provided with grease, to reduce friction, dirt sticks unless it is kept away by an encapsulation according to the invention. The mixture of grease and dirt forms a kind of abrasive paste, which quickly wears away the lubricated parts moving relative to one another. Another advantage of the encapsulation is that a lubricant is kept at the moving parts and is not lost. The encapsulation makes permanent lubrication with a lubricant supply possible. Friction that remains the same within the closest possible limits is important for a disk brake that has self-boosting, since friction affects the magnitude of the self-boosting.

Features of the invention, and in particular the ramp mechanism of claim 1, the retainer for the roller bodies of claim 6, the three-point support of claim 3, the encapsulation of moving parts of claim 7, and a contate gear mechanism of claim 10, may be realized jointly with other features or individually on their own.

### DRAWING

The invention is described in further detail below, in terms of an exemplary embodiment shown in the drawing. Shown are:

FIG. 1, a sectional view, seen radially from outside, of an electromechanical disk brake of the invention;

FIG. 2, a view of a ramp plate of the disk brake, in the direction of the arrow II in FIG. 1.

The drawing should be understood as a simplified, schematic illustration.

### DESCRIPTION OF THE EXEMPLARY EMBODIMENT

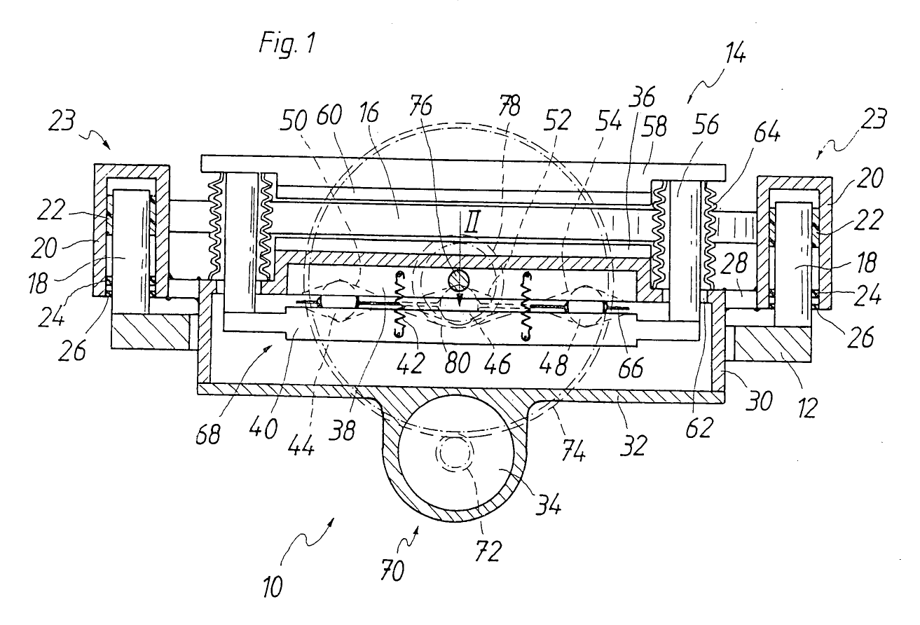

The electromechanically actuatable disk brake 10 according to the invention, shown in FIG. 1, is a partial-lining disk brake 10; that is, its friction brake linings cover a brake disk 16 only partly in the circumferential direction, over less than a quarter-circle in the exemplary embodiment of the invention shown and described. The partial-lining disk brake 10 has a brake retainer 12, on which a brake caliper 14 is guided displaceably, transversely to a brake disk 16. The brake caliper 14 is accordingly a so-called floating caliper. For guidance of the brake caliper 14, the brake retainer 12 has two bolts 18, disposed vertically to the brake disk 16, on which bolts bushes 20 that are connected to the brake retainer 12 are guided displaceably. For reducing friction, slide bearings 22 are inserted into the bushes 20. The bushes 20 are sealed off with sealing rings 24 on the bolts 18, so that a grease filling in the bushes 20 is retained, and water is prevented from entering. Dirt scraper rings 26 are inserted into the bushes 20 on the outsides of the sealing rings 24 and prevent dirt from entering. The bolts 18 and the bushes 20 form a caliper guide 23 for the floating guidance, that is, guidance displaceable transversely to the brake disk 16, of the brake caliper 14. The bushes 20 form an encapsulation of the caliper guides 23 of the brake caliper 14, which are sealed off by the sealing rings 24 and the dirt scraper rings 26 against an escape of grease and a penetration of water and dirt. The reverse disposition of the bushes 20 on the brake retainer 12 and of the bolts 18 on the brake caliper 14 is also possible.

The slide bearings 22 of the guidance of the brake caliper 14 transversely to the brake disk 16 are disposed in an imaginary plane with the brake disk 16. A moment-free bracing of the brake caliper 14 about an imaginary axis, located in the plane of the brake disk, is attained.

Upon release of the partial-lining disk brake 10, an actuating device 70 still to be explained hereinafter restores a ramp plate 40 to its original position, so that indentations in two ramp plates 38, 40, which indentations form ramps 50, 52, 54 are located diametrically opposite one another. Tension spring elements 42, which pull the two ramp plates 38, 40 together, cause the second friction brake lining 60 to lift from the brake disk 16. The two sealing rings 24, because of their elasticity, lift the other, first friction brake lining 36 from the brake disk 16.

The sealing rings 24 and the dirt scraper rings 26 brace the brake caliper 12 against tilting, because of their disposition laterally beside the slide bearings 22. The slide bearings 22 are not acted upon by a tilting moment that results from a force of gravity of the brake caliper 12 that engages laterally of the slide bearings 22.

The bushes 20 are solidly joined via webs 28 to a housing 30, which is part of the brake caliper 14. The housing 30 is a shallow, box-shaped housing 30, which in a side view, not shown, is curved in a circular arc to correspond to a circumference of the brake disk 16. The housing 30 is closed with a housing cap 32 on a side facing away from the brake disk 16. The housing cap 32 supports an electric motor 34, whose imaginary motor axis extends parallel to the brake disk 16 and intersects an imaginary axis of rotation of the brake disk 16.

A first friction brake lining 36 is disposed on an outer side of the housing 30, facing toward the brake disk 16.

In the housing 30, there are two ramp plates 38, 40, which are disposed parallel to one another and to the brake disk 16. One ramp plate 38 is disposed fixedly in the housing 30, and the other ramp plate 40 is located on a side, facing away from the brake disk 16, of the fixed ramp plate 38 and is movable in the housing 30. Tension spring elements 42 pull the ramp plates 38, 40 together and connect the ramp plates 38, 40 spring-elastically.

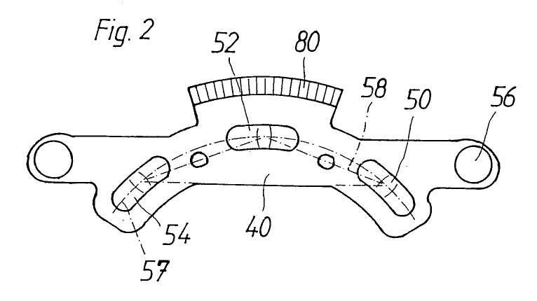

The two ramp plates 38, 40 are braced against one another via three balls 44, 46, 48, which are disposed between the ramp plates 38, 40. For guiding the balls 44, 46, 48, congruent, groovelike indentations are made in faces, oriented toward one another, of the ramp plates 38, 40 and form ramp paths or simply ramps 50, 52, 54. The shape and course of the ramps 50, 52, 54 can be readily seen in the view of the moving ramp plate 40 shown in FIG. 2. The ramps 50, 52, 54 extend along an imaginary circular-arc line 57 about a common, imaginary axis, which at least approximately coincides with an axis of rotation of the brake disk 16. Because of the disposition of the ramps 50, 52, 54 on the circular-arc line 57, the ramps 50, 52, 54 and thus also the balls 44, 46, 48 are located at the three corners of an imaginary triangle 58 (FIG. 2); the balls 44, 46, 48 form a statically defined three-point support for the two ramp plates 38, 40.

The ramps 50, 52, 54 need not be disposed on a common circular-arc line 57 as in the exemplary embodiment shown of the invention; the ramps 50, 52, 54 may instead be disposed on two or three different circular-arc lines that are concentric to one another (not shown). In that case, the circular-arc lines have different radii. For instance, the middle ramp 52 may also be disposed radially inside the two outer ramps 50, 54 and radially inside an imaginary straight line connecting the two outer ramps 50, 54. What is important is the statically defined three-point support of the moving ramp plate 40.

The indentations, forming the ramps 50, 52, 54, in the ramp plates 38, 40 become shallower from their centers to each of their two ends; they guide the balls 44, 46, 48 along imaginary helical paths. The slopes of the helical paths is the same for all three balls 44, 46, 48; that is, upon a defined displacement of the ramp plates 38, 40 counter to one another, a spacing of the ramp plates 38, 40 increases identically at all the balls 44, 46, 48, and the ramp plates 38, 40 remain parallel to one another. The ramps 50, 52, 54 and the balls 44, 46, 48 guide the moving plate 40 displaceably along the imaginary circular-arc line 57 on the fixed ramp plate 38. Since the circular-arc line 57 is concentric to the axis of rotation of the brake disk 16, the moving ramp plate 40 is guided rotatably about the axis of rotation of the brake disk 16.

Via bolts 56, the moving ramp plate 40 is fixedly joined to a plate 58, which is located on a diametrically opposite side of the brake disk 16 and which carries a second friction brake lining 60. The bolts 56 pass through holes 62 of the housing 30, and the holes 62 are embodied as circular-arclike oblong slots, so that the displacement, described in the previous paragraph, of the moving ramp plate 40 is possible. Outside the housing 30, the bolts 56 are enclosed by bellows 64, which press tightly against the housing 30 and against the plate 58. In this way, the moving parts accommodated in the housing 30, especially the balls 44, 46, 48 and the two ramp plates 38, 40, are hermetically enclosed. The housing 30 together with the bellows 64 forms an encapsulation for both the moving and the fixed parts accommodated in it.

The moving ramp plate 40, the plate 58, and the bolts 56 firmly connecting these two plates 40, 58 form a frame 40, 56, 58, which braces the second friction brake lining 60. The two bolts 56 are located at the level of an imaginary straight line through a center point of the area of the friction brake lining 60, so that the bolts 56 are stressed essentially only for tension and not for bending. A bending stress on the bolts 56 occurs, because of a frictional force exerted upon braking by the rotating brake disk 16 on the second friction brake lining 60, and upon bending of the plates 40, 58 when the friction brake linings 36, 60 are pressed against the brake disk 16. The two plates 40, 58 are likewise located at the level of the aforementioned straight line, so that the two plates 40, 58 are stressed solely for bending and not for torsion. In this way, a rigid frame 40, 56, 58 can be realized.

While in the exemplary embodiment of the invention shown and described, the housing 30 is fixed in the direction of rotation of the brake disk 16 and the frame 40, 56, 58 is pivotable, it is conversely possible in other embodiments of the invention for the frame 40, 56, 58 to be fixed and the housing 30 to be pivotable (not shown).

The three balls 44, 46, 48 are received rotatably in a retainer 66, which keeps the balls 44, 46, 48 in their spacing from one another and their disposition relative to one another. The retainer 66 is embodied as a stamped and bent sheet-metal part on the order of a ball cage, of the kind known from ball bearings. The middle ball 46 in terms of FIG. 1 is located above the sectional plane and is therefore represented by dashed lines. The two outer balls 44, 48 can be seen only in the gap between the two ramp plates 38, 40; concealed portions of the balls 44, 48 are represented by dashed lines. The retainer 66 is also located, in its middle region, above the sectional plane and is therefore represented by dashed lines in its middle region.

For actuation of the disk brake 10, the moving ramp plate 40 is displaced relative to the fixed ramp plate 38 by an electromechanical actuating device, to be described hereafter, in the circumferential direction of the brake disk 16, or in other words in the direction of the imaginary circular-arc line 57. The displacement of the moving ramp plate 40 takes place in the direction of rotation of the brake disk 16. As a result, the balls 44, 46, 48 roll along the ramps 50, 52, 54 and press the ramp plates 38, 40 apart. Via the bolts 56, the moving ramp plate 40 pulls the plate 58 toward the brake disk 16 and as a result presses the second friction brake lining 60 against the brake disk 16. Upon further displacement of the ramp plates 38, 40 counter to one another, the brake caliper 14 with the housing 30 is displaced transversely to the brake disk 16 and presses one friction brake lining 36 against the other side of the brake disk 16. A frictional and braking force is exerted on the brake disk 16. A frictional force exerted by the rotating brake disk 16 on the second friction brake lining 60 acts in the circumferential direction of the brake disk 16. This frictional force is transmitted via the bolts 56 to the moving ramp plate 40 and exerts a force acting in the circumferential direction of the brake disk 16 upon the ramp plate 40. This force acts in the direction of the imaginary circular-arc line 57, along which the balls 44, 46, 48 and the ramps 50, 52, 54 guide the moving ramp plate 40. The frictional force exerted by the rotating brake disk 16 on the second friction brake lining 60 accordingly brings about a force in the circumferential direction on the moving ramp plate 40, in addition to the force exerted by the actuating device. The ramps 50, 52, 54 and the balls 44, 46, 48 convert the force in the circumferential direction into an additional contact pressure transversely to the brake disk 16, with which force the friction brake linings 36, 60 are pressed against the brake disk 16. The result is a boosting of the braking force. The balls 44, 46, 48 and the ramps 50, 52, 54 thus form a ramp mechanism 68 of a self-booster of the disk brake 10. The housing 30 forms an encapsulation of the self-booster 68.

The actuating device 70 has, in addition to the electric motor 34, a two-stage gear wheel mechanism. The gear wheel mechanism has a pinion 72, on a motor shaft of the electric motor 34, which meshes with a large gear wheel 74, which is disposed parallel to a tangential plane of the brake disk 16, outside the circumference of the brake disk. The large gear wheel 74 is connected in a manner fixed against relative rotation, via a shaft 76, to a small gear wheel 78, which meshes with a rack 80 of the moving ramp plate 40. The shaft 74 is supported rotatably in the housing 30 or in the fixed ramp plate 38. The rack 80 extends in both directions from its center obliquely to the fixed ramp plate 38, and the rack 80, like the ramps 50, 52, 54, extends obliquely at an angle to the brake disk 16, the angle of the rack 80 to the brake disk 16 being more acute than the angle of the ramps 50, 52, 54 to the brake disk 16, since the rack 80 is located radially outside the ramps. The rack 80 has the same slope as the ramps 50, 52, 54.

In FIG. 2, the rack 80 can be seen in an elevation view. It likewise extends in a circular arc, concentrically to the axis of rotation of the brake disk 16. More precisely, beginning at its middle, the rack 80 extends in a helical path in each direction, with the same slope as the ramps 50, 52, 54. The same slope means that for a defined displacement of the ramp plate 40 in the circumferential direction of the brake disk 16, a rise of the rack 80 and of the ramps 50, 52, 54 transversely to the brake disk 16 are of the same magnitude. Because of this course of the rack 80, meshing of the small gear wheel 78 with the rack 80 in a structurally provided way is assured.

The disposition of the rack 80 radially outside the ramps 50, 52, 54 produces a desired lever effect; the rack 80 has a long lever arm relative to the axis of rotation of the moving ramp plate 40. The axis of rotation of the ramp plate 40 coincides with the axis of rotation of the brake disk 16. As a result, there is a large boost in force of the actuating device 70 of the partial-lining disk brake 10. The rack 80 is located radially as far as possible toward the outside on a radially outer edge of the ramp plate 40.

The housing forms an encapsulation for the gear wheel mechanism 72, 74, 78, as well; to that end, it has a shallow, hollow-cylindrical housing portion, not visible in the drawing, in which especially the large gear wheel 74 is received. The gear wheels 72, 74, 78 are located above the plane of the section in FIG. 1 and are therefore represented by dashed lines.

For braking in the opposite direction of rotation of the brake disk 16 (traveling in reverse), the moving ramp plate 40 is displaced in the opposite direction; that is, for braking, the moving ramp plate 40 is always displaced in the direction of rotation of the brake disk 16.

The small gear wheel 78 and the rack 80 are embodied as a so-called contate gear mechanism (plane spur gear mechanism), with the special feature that the toothing of the rack 80 is not located in one plane but instead is in the helical shape described above. The small gear wheel 78 is embodied as a straight-toothed spur gear, and the rack 80 forms the contate gear. A contate gear mechanism has the advantage of being invulnerable to positional tolerances of the two meshing gear wheels 78, 80. An advantage of the use of a straight-toothed spur gear 78, which use is possible because of the contate gearing, is that no axial forces act on the spur gear 78. The rotational support of the shaft 76 need not therefore withstand any significant axial forces. A further advantage is that axial adjustment of the spur wheel 78 can be dispensed with.

The gear mechanism shown and described and called a contate gear mechanism can also be conceived as a gear mechanism of its own type, since the gear has a rack 80, instead of a plate wheel, which furthermore extends not flatly but rather helically. Regardless of what the gear is correctly called, the axial tolerance for the spur gear wheel 78, which may also have an oblique toothing is an important property of the gear.

1-13. (canceled)

14. In a electromechanical partial-lining disk brake with self-boosting, having an actuating device, having a friction brake lining, which for braking can be pressed by the actuating device against a brake disk, and having a self-booster, which converts a frictional force, exerted by the brake disk on the friction brake lining when the friction brake lining is pressed against the rotating brake disk, into a contact pressure which presses the friction brake lining against the brake disk, the improvement wherein the self-booster has a ramp mechanism; and wherein the ramps of the ramp mechanism have a helical course that is concentric to one another and at least approximately concentric to an axis of rotation of the brake disk and guide the friction brake lining, for pressing against the brake disk, both transversely to the brake disk (feed motion) and approximately in a circular arc in the circumferential direction to the brake disk.

15. The electromechanical partial-lining disk brake according to claim 14, wherein ramp mechanism comprises roller bodies; and wherein the ramps guide the roller bodies along helical paths having the same slope.

16. The electromechanical partial-lining disk brake according to claim 15, wherein the ramp mechanism comprises three balls as roller bodies, which are disposed at corners of an imaginary triangle.

17. The electromechanical partial-lining disk brake according to claim 16, wherein a center point of the area of the friction brake lining, braced with the roller bodies, is located inside the imaginary triangle.

18. The electromechanical partial-lining disk brake according to claim 15, wherein the roller bodies are retained with a retainer, which keeps the roller bodies in their spacing from and in their position relative to one another.

19. The electromechanical partial-lining disk brake according to claim 14, wherein the disk brake comprises a frame, on which the friction brake lining is braced on being pressed against the brake disk, and which is located approximately at the same level as a center point of the area of the friction brake lining.

20. The electromechanical partial-lining disk brake according to claim 14, wherein the disk brake comprises an encapsulation of moving parts.

21. The electromechanical partial-lining disk brake according to claim 20, wherein the disk brake comprises a floating caliper, in which the friction brake lining rests and which is guided displaceably by a caliper guide transversely to the brake disk; and wherein the caliper guide comprises an encapsulation.

22. The electromechanical partial-lining disk brake according to claim 20, wherein the disk brake comprises an encapsulation for the actuating device and/or the self-booster.

23. The electromechanical partial-lining disk brake according to claim 14, wherein the actuating device comprises a contate gear mechanism for displacing the ramps of the ramp mechanism relative to one another.

24. The electromechanical partial-lining disk brake according to claim 14, wherein a brake caliper comprises a slide bearing, with which it is guided displaceably transversely to the brake disk; and wherein the slide bearing is disposed approximately in an imaginary plane with the brake disk.

25. The electromechanical partial-lining disk brake according to claim 24, wherein the brake caliper comprises a brace against tilting, for relieving the slide bearing.

26. The electromechanical partial-lining disk brake according to claim 14, wherein that the actuating device engages the ramp mechanism with a long lever arm radially relative to the brake disk outside the ramps.
